(19) United States
(12) Patent Application Publication
(10) Pub. No.: US 2011/0044342 A1
(43) Pub. Date: Feb. 24, 2011

(54) METHOD FOR POPULATING A FORWARDING INFORMATION BASE OF A ROUTER AND ROUTER

(75) Inventor: Rolf Winter, Heidelberg (DE)

Correspondence Address: YOUNG & THOMPSON, 209 Madison Street, Suite 500, Alexandria, VA, 22314, US

(73) Assignee: NEC Europe Ltd, Heidelberg (DE)

(21) Appl. No.: 12/990,692

(22) PCT Filed: Jun. 9, 2009
(86) PCT No.: PCT/EP2009/004128

§ 371 Date: Nov. 2, 2010

(30) Foreign Application Priority Data
Jun. 13, 2008 (EP) 08 010 800 4

(51) Int. Cl. H04L 12/56

(52) U.S. Cl. 370/392

(57) ABSTRACT

A method for populating a forwarding information base of a router of an autonomous system (AS) in the Internet's Default Free Zone (DFZ), wherein the forwarding information base contains a multitude of entries, each entry mapping a destination prefix to at least one route to reach the destination prefix, is characterized in that for each prefix advertised to the router, the autonomous system (AS) the advertisement was received from is determined, and that a decision is made whether to include the prefix into the forwarding information base of the router or not, wherein in the decision the autonomous system (AS) and/or predefined characteristics of the autonomous system (AS) the prefix is learned from is/are considered. Furthermore, a corresponding router for deployment in autonomous systems (AS) in the Internet's Default Free Zone (DFZ) is disclosed.

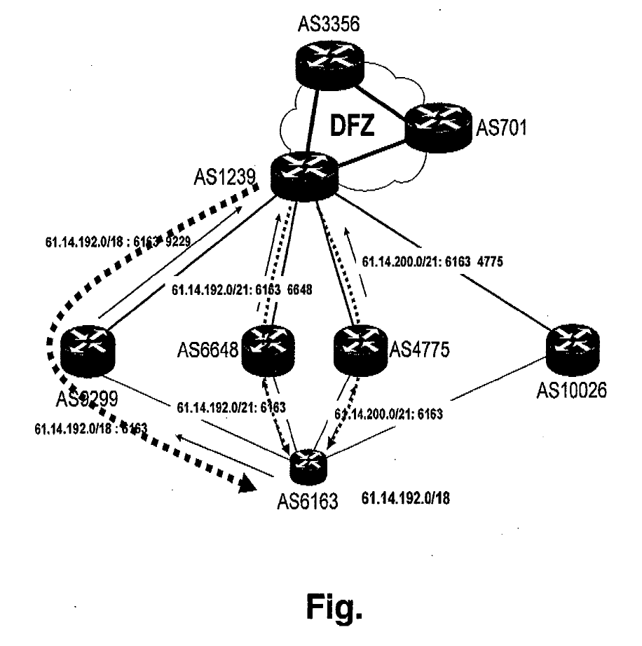

The present invention relates to a method for populating a forwarding information base of a router of an autonomous system (AS) in the Internet's Default Free Zone (DFZ), wherein the forwarding information base contains a multitude of entries, each entry mapping a destination prefix to at least one route to reach said destination prefix.

Furthermore, the present invention relates to a router for deployment in autonomous systems (AS) in the Internet's Default Free Zone (DFZ), comprising a forwarding information base and/or a routing table, wherein the forwarding information base and/or the routing table contain a multitude of entries, each entry mapping a destination prefix to at least one route to reach said destination prefix.

Today's Internet comprises thousands of autonomous systems (AS), each of which is one or a collection of networks under the control of a single administrative entity. Within the Internet each network interface is identified by means of an IP address which is, in case of IPv4 a 32-bit number. Due to scalability reasons with respect to the Internet routing infrastructure, IP addresses are aggregated into contiguous blocks. Such blocks are called prefixes and consist of an IP address and a mask, the latter one indicating the number of leftmost contiguous significant bits. For instance, the prefix notation 61.14.192.0/18 refers to a prefix with a mask length of 18-bits and thus leaves 14-bits to be used by the owning organization including further assignment of sub-prefixes to customers.

Using the Boarder Gateway Protocol (BGP) routers exchange reachability information in form of these prefixes which are stored in routing tables. The ones a router is using to actually forward data packets are included in the forwarding information base (FIB). In current systems the FIB typically contains a one-to-one mapping between a destination prefix and a route how to reach that destination prefix.

Both routing tables and forwarding information bases have experienced a steeply increasing number of entries over the past years. This development is to be regarded as extremely critical, in particular with respect to the Internet's Default Free Zone (DFZ). The DFZ is the Internet's core and, in the context of Internet routing, refers to the entirety of all ASes in the Internet, where the global routing states accumulate. Thus, routers of an AS belonging to the DFZ do not require a default route to route a packet to any destination. For instance, tier-1 Internet providers are part of the DFZ.

As already indicated above, today the Internet's DFZ is suffering from an enormous increase in the number of entries in both forwarding information bases and routing tables. The mere size is not the only scalability problem, but also the update rate this state is subject to is increasing at an alarming rate.

The fundamental problem is that autonomous systems (AS) at the edge of the Internet de-aggregate the address prefixes that are assigned to them for various purposes, most notably for the purpose of inbound traffic engineering (TE). An example is shown in the FIGURE where AS6163 disaggregates prefix 61.14.192.0/18 by advertising, via BGP, two longer prefixes to AS6648 and AS4757, thus distributing the incoming traffic. Since current routers use longest-prefix matching when forwarding packets, packets destined to AS6163 with an address that does not match the longer /21 prefixes will go through AS9299, which is the AS that the /18 prefix was advertised through. In the FIGURE inbound traffic flows are represented by the dashed lines.

The problem of de-aggregation cannot be solved by aggregating prefixes at upstream autonomous systems (e.g. AS1239 in the FIGURE), since operators need to perform traffic engineering and there are currently no other means to do this (aggregating at AS1239 would result in all traffic for the /18 flowing through AS9229). Unfortunately, the operators that disaggregate prefixes, such as AS6163 in the example illustrated in the FIGURE, do not carry the cost of this action; rather, it is the routers in the Default Free Zone DFZ, i.e. in the part of the Internet where the global routing state accumulates, that do so. Consequently, there is little incentive to stop this practice. In the not-so-distant future these developments might significantly hamper convergence, leading to instability in global connectivity.

It is therefore an object of the present invention to improve and further develop a method and a router of the initially described type for deployment in autonomous systems in the Internet's Default Free Zone in such a way that by employing mechanisms that are readily to implement the size of routing tables and forwarding information bases in the Default Free Zone of the Internet is reduced.

In accordance with the invention, the aforementioned object is accomplished by a method comprising the features of claim 1. According to this claim, such a method is characterized in that for each prefix advertised to said router, the autonomous system (AS) the advertisement was received from is determined, and that a decision is made whether to include the prefix into the forwarding information base of said router or not, wherein in said decision the autonomous system (AS) and/or predefined characteristics of the autonomous system (AS) said prefix is learned from is/are considered.

Furthermore, the aforementioned object is accomplished by a router comprising the features of independent claim 7. According to this claim, such a router is characterised in that the router further comprises inspection means for determining for each advertised prefix the autonomous system (AS) the advertisement was received from, and processing means for including the prefix into said forwarding information base and/or into said routing table, said processing means being configured to make a decision of whether to include the prefix into said forwarding information base and/or said routing table or not, and to depend said decision on the autonomous system (AS) and/or predefined characteristics of the autonomous system (AS) said prefix is learned from.

According to the invention it has been recognized that the problem of growing size of routing tables and forwarding information bases can be handled by applying a more individual treatment of prefixes. To allow for a differentiation it is determined for each prefix advertised to a router of an AS belonging to the DFZ the AS the prefix is learned from. To this end, the router according to the invention includes appropriate inspection means. The information regarding the AS the prefix is learned from is used for making a decision of whether to include the prefix into the forwarding information base of the router or not. To this end, the router according to the invention includes appropriate processing means being configured to make such decision.

According to the invention, the decision of whether to include the prefix into the routing table of the router or not is based on the prefix advertisement originating AS and/or on predefined characteristics thereof. By introducing such differentiation in prefix treatment, the size of routing tables and forwarding information bases in the Default Free Zone of the Internet is reduced, thus reducing the associated churn. The method and the router according to the invention do not require any changes to the routing protocol itself, i.e. protocol messages and headers do not need to be touched.

According to a preferred embodiment a check is performed for each prefix advertised to the router, whether the advertisement was received from a non-DFZ autonomous system or from a DFZ autonomous system. By performing such check the different prefix treatment can be based on a specific characteristic of the AS the prefix was received from, namely whether it belongs to the DFZ or whether it does not belong to the DFZ. When considering the relationship among the ASes, a non-DFZ AS can be regarded as customer AS, whereas a DFZ AS functions as peering or transit AS. Thus, different prefix treatment may be realized on the basis of checking whether the AS the prefix was learned from is a customer AS or whether the advertisement comes from a peering or transit AS through the DFZ.

Preferably, advertised prefixes originating from non-DFZ autonomous systems (i.e. customer ASes) may be included into the router's forwarding information base. In other words, prefixes learned from non-DFZ ASes may be treated exactly as they are in the current Internet.

According to a particularly preferred embodiment, advertised prefixes learned from DFZ ASes (i.e. transit ASes or peering ASes in the case of tier-1 providers) may be included into the router's forwarding information base only if the prefix is shorter than the prefix of an existing entry. The included shorter prefix will then replace the existing longer prefix. By this means the amount of prefixes populating the forwarding information bases is significantly reduced while still satisfying the traffic engineering needs of customers. Only a subset of Internet routers needs to change their local decision algorithm. This involves modifying the algorithm that populates the forwarding information base. The configuration needed for this is minimal as it is a per-BOP peer decision, i.e. it can be applied to a whole BGP session. The major positive effect is that edge ASes still achieve their goals but the Internet DFZ is relieved of considerable stress, what cannot be achieved with simple aggregation. Furthermore, this means is conceptually elegant with potentially huge gains. It is expected that it would be applicable to ˜50% of the prefixes in the DFZ at the tier-1 level.

It is to be noted that packets that travel through the DFZ will still adhere to the traffic engineering goals of autonomous systems at the edge of the Internet as the AS that has the destination AS of a packet as a customer still keeps the full disaggregated routing information. However, DFZ ASes that do not have the destination AS as a customer only keep an aggregate of the disaggregated prefixes, In other words, a fraction of the more specific prefixes in the DFZ is filtered. On the other hand, complex filter and policy rules, which are common today, are not required.

According to a further preferred embodiment, consecutive prefixes learned from DFZ ASes are aggregated to larger ones, thereby further reducing the amount of entries in the forwarding information bases. Again, even aggressively aggregating prefixes learned from ASes that provide transit, i.e. are part of the DFZ, does not jeopardize inbound traffic engineering goals of customers. For performing aggregation, it is not necessary to change the current inter-domain routing protocol (BGP). All that is required is that the address format allows aggregation, as clearly IPv4 and IPv6 addresses do.

According to a still further preferred embodiment, the mechanism described for populating a router's forwarding information base can be applied in the same way for populating also a router's routing table.

There are several ways how to design and further develop the teaching of the present invention in an advantageous way. To this end, it is to be referred to the patent claims subordinate to patent claims 1 and 7 and to the following explanation of a preferred example of an embodiment of the invention, illustrated by the FIGURE on the other hand. In connection with the explanation of the preferred example of an embodiment of the invention by the aid of the FIGURE, generally preferred embodiments and further developments of the teaching will be explained. In the drawings the only

FIGURE illustrates schematically the principal structure of the Internet including a router in the Internet's DFZ according to an embodiment of the present invention.

In the only FIGURE the basic setup of today's Internet is illustrated. The Internet constitutes of a multitude of autonomous systems AS which can be divided into DFZ ASes, i.e. ASes belonging to the DFZ of the Internet, and into non-DFZ ASes, i.e. ASes outside the DFZ located in the edge regions of the Internet. Additionally, from each AS's perspective directly connected ASes can be classified as customers, peers or transit ASes. In the FIGURE, by way of example, three DFZ (tier-1) ASes are depicted, AS3356, AS701, and AS1239. Furthermore, a total of five non-tier-1 ASes are depicted, which are referred to as AS9299, AS6648, AS4775, AS10026, and AS6163.

The method according to the invention targets the routers in the Default Free Zone of the Internet, in other words, routers that locally know a route to every destination in the Internet. In the current Internet, routers' forwarding information bases (FIBS) are populated not only with small prefixes, but also with larger ones that may be contained by the smaller ones (for instance, a FIB could contain 61.14.192.0/18 as well as 61,14.192.0/21). When forwarding packets, the router performs a longest-prefix match, meaning that it will use the FIB entry that matches the packet's address and has the longest prefix; this algorithm allows basic inbound traffic engineering in the current Internet. Unfortunately, longest-prefix matching also results in the global routing tables growing rapidly if disaggregation becomes common place for traffic engineering purposes.

Going back to the FIGURE, in the current Internet AS1239 will apply longest-prefix matching to routes learned from the four customer ASes AS9299, AS6648, AS4775 and AS10026. While the current algorithm will populate the FIB with all three prefixes being advertised (61.14,192.0/18, 61.14.192.0/21 and 61.14.200.0/21), the method according to the invention aims at populating the FIB differently. According to a specific embodiment of the invention the differentiated FIB population is based on whether a prefix was learned from a customer AS or from a non-customer AS. Prefixes learned from customers ASes are treated exactly as they are in the current Internet. However, a route learned from non-customer ASes will only be included in the FIB if it has a shorter prefix than an existing entry, reducing the amount of prefixes learned while still satisfying the traffic engineering needs of customers.

Following the example in the FIGURE, routers of AS1239 will only populate theirs FIBs with routes learned from AS3356 and AS701 representing shortest prefixes. This action will specifically filter out very small, disaggregated prefixes such as /24s which cause much of the global routing table churn.

It is to be noted that with applying the method as described above, packets that travel through the DFZ will still adhere to the traffic engineering goals of ASes at the edge of the Internet: the AS that has the destination AS as a customer still keeps the full, disaggregated routing information. According to the example shown in the FIGURE, AS1239 still maintains all the routes advertised by AS6163 as the ASes it receives the advertisement from (AS9229, AS6646 and AS4775) are all customers. However, DFZ ASes that do not have the destination AS as a customer (i.e. AS3356 and AS701) only keep an aggregate of the disaggregated prefixes (i.e. the /18). In other words, the method filters a fraction of the more specific prefixes in the DFZ.

Additionally, for prefixes learned from non-customer ASes, consecutive prefixes are aggregated to larger ones, further reducing the amount of state. Referring to the FIGURE and considering the prefixes 61.14.192.0/21 and 61.14.200.0/21, if they were received from another DFZ AS, these would be aggregated into a /20, but again, only if they came from a non-customer or peering AS in the tier-1 case. This means that there are no complicated filtering rules necessary based on known prefixes but it applies to, for example, whole BGP sessions.

Many modifications and other embodiments of the invention set forth herein will come to mind the one skilled in the art to which the invention pertains having the benefit of the teachings presented in the foregoing description and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

1. Method for populating a forwarding information base of a router of an autonomous system (AS) in the Internet's Default Free Zone (DFZ), wherein the forwarding information base contains a multitude of entries, each entry mapping a destination prefix to at least one route to reach said destination prefix, characterized in that for each prefix advertised to said router, the autonomous system (AS) the advertisement was received from is determined, and that a decision is made whether to include the prefix into the forwarding information base of said router or not, wherein in said decision the autonomous system (AS) and/or predefined characteristics of the autonomous system (AS) said prefix is learned from is/are considered.

2. Method according to claim 1, wherein a check is performed for each prefix advertised to said router, whether the advertisement originates from a non-DFZ autonomous system (AS) or from a DFZ autonomous system (AS).

3. Method according to claim 1, wherein advertised prefixes learned from non-DFZ autonomous systems (AS) are included into said router's forwarding information base.

4. Method according to claim 1, wherein advertised prefixes originating from DFZ autonomous systems (AS) are included into said router's forwarding information base only if the prefix is shorter than the prefix of an existing entry.

5. Method according to claim 1, wherein prefixes learned from DFZ autonomous systems (AS) are aggregated.

6. Method according to claim 1, the method being applied for populating the router's routing table.

7. Router for deployment in autonomous systems (AS) in the Internet's Default Free Zone (DFZ), comprising a forwarding information base and/or a routing table, wherein the forwarding information base and/or the routing table contain a multitude of entries, each entry mapping a destination prefix to at least one route to reach said destination prefix,
characterized in that the router further comprises
inspection means for determining for each advertised prefix the autonomous system (AS) the advertisement was received from, and
processing means for including the prefix into said forwarding information base and/or into said routing table, said processing means being configured to make a decision of whether to include the prefix into said forwarding information base and/or said routing table or not, and to depend said decision on the autonomous system (AS) and/or predefined characteristics of the autonomous system (AS) said prefix is learned from.

8. Router according to claim 7, wherein said inspection means are configured to perform a check for each prefix advertised to said router, whether the advertisement originates from a non-DFZ autonomous system (AS) or from a DFZ autonomous system (AS).

9. Router according to claim 7, wherein said processing means are configured to include advertised prefixes originating from non-DFZ autonomous systems (AS) into said router's forwarding information base and/or said router's routing table.

10. Router according to, wherein said processing means are configured to include advertised prefixes originating from DFZ autonomous systems (AS) into said router's forwarding information base and/or said router's routing table only if the prefix is shorter than the prefix of an existing entry.

11. Method according to claim 2, wherein advertised prefixes learned from non-DFZ autonomous systems (AS) are included into said router's forwarding information base.

12. Router according to claim 8, wherein said processing means are configured to include advertised prefixes originating from non-DFZ autonomous systems (AS) into said router's forwarding information base and/or said router's routing table.

13. Router according to claim 8, wherein said processing means are configured to include advertised prefixes originating from DFZ autonomous systems (AS) into said router's forwarding information base and/or said router's routing table only if the prefix is shorter than the prefix of an existing entry.

14. Router according to claim 9, wherein said processing means are configured to include advertised prefixes originating from DFZ autonomous systems (AS) into said router's forwarding information base and/or said router's routing table only if the prefix is shorter than the prefix of an existing entry.
